(19) United States
(12) Patent Application Publication
(10) Pub. No.: US 2013/0324325 A1
(43) Pub. Date: Dec. 5, 2013

(54) Golf Ball With Interlocking Layers And Method Of Making Same

(71) Applicant: Kerby LaVar Maxwell, Portland, OR (US)

(72) Inventor: Kerby LaVar Maxwell, Portland, OR (US)

(73) Assignee: NIKE, Inc., Beaverton, OR (US)

(21) Appl. No.: 13/485,484

(22) Filed: May 31, 2012

(51) Int. Cl. A63B 37/00; B28B 5/00

(52) U.S. Cl. 473/377; 473/371; 264/250

(57) ABSTRACT

A golf ball with interlocking layers is disclosed. The interlocking layers are generally provided to inhibit slippage of the adjacent layers, particularly between incompatible materials that are difficult to adhere together. Thus, the interlocking layers inhibit the development of dead spots within the ball, which occurs when the layers delaminate. A method of making a golf ball with interlocking layers using a dual molding process is also disclosed.

### BACKGROUND

The present invention relates generally to a golf ball having different play characteristics in different situations.

The game of golf is an increasingly popular sport at both amateur and professional levels. A wide range of technologies related to the manufacture and design of golf balls are known in the art. Such technologies have resulted in golf balls with a variety of play characteristics and durability. For example, some golf balls have a better flight performance than other golf balls. Some golf balls with a good flight performance do not have a good feel when hit with a golf club. Some golf balls with good performance and feel lack durability. Thus, it would be advantageous to make a durable golf ball with a good flight performance that also has a good feel.

### SUMMARY

A golf ball includes interlocking layers. The interlocking layers engage with each other to inhibit slippage between the layers when the golf ball is struck by a club. Inhibiting slippage and delamination may help prevent dead spots from forming in the ball, as dead spots can negatively impact ball performance. The layers engage with each other due to complementary surface texture on the layers. At the interface of the layers, where a surface of a first layer faces a surface of an adjacent layer, surface texture is provided on each surface, where the surface texture of the first layer is configured to engage with the surface texture of the adjacent layer. The surface texture may have any size or shape, but in some embodiments the surface texture is small in size compared to the golf ball dimples.

In one aspect, the invention provides a solid golf ball, the solid golf ball comprises a first layer having a first surface texture on a first surface; and a second layer having a second surface texture on a second surface, wherein the second surface is adjacent to and touches the first surface, and wherein the first surface texture is configured to interlock with the second surface texture.

In another aspect, the invention provides a method of making a golf ball, the method comprising the steps of forming a first layer in a first mold, wherein the first mold has a mold surface with a first surface texture so that a first surface of the first layer is textured during the molding process with a second surface texture; positioning the first layer in a mold cavity of a second mold so that a gap is provided between the first layer and a second mold surface; and introducing material into the gap so that the material conforms to the second surface texture of the first surface of the first layer.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an exemplary embodiment of a golf ball configuration of a two-piece golf ball;

FIG. 2 is an exemplary embodiment of a golf ball configuration of a three-piece golf ball;

FIG. 3 is another exemplary embodiment of a golf ball configuration of a three-piece golf ball;

FIG. 4 is an exemplary embodiment of a golf ball configuration of a four-piece golf ball;

FIG. 5 is a schematic partial cross-sectional view of an embodiment of a golf ball with interlocking layers;

FIG. 6 is a schematic partial peel-away view of an embodiment of the golf ball of FIG. 5, showing the surface texture on a first layer;

FIG. 7 shows an enlarged view of the surface texture of the first layer of FIG. 6;

FIG. 8 shows an enlarged view of an alternate embodiment of surface texture of the first layer of FIG. 5;

FIG. 9 is a schematic partial cross-sectional view of another embodiment of a golf ball with interlocking layers;

FIG. 10 shows an enlarged view of the surface texture of the first layer of FIG. 9;

FIG. 11 shows an enlarged view of an alternate embodiment of surface texture of the first layer of FIG. 9;

FIG. 12 shows a flow diagram of an embodiment of a method of making a golf ball with interlocking layers;

FIG. 13 shows a schematic, cross-sectional view of a first mold having mold surfaces to impart a first texture to a first layer of a golf ball with interlocking layers, with the mold in an open an empty configuration;

FIG. 14 shows the mold of FIG. 13 in a closed configuration with an embodiment of a golf ball core positioned within the mold cavity;

FIG. 15 is a cross-sectional view of the molded product from the molding step shown in FIG. 14, with a textured layer provided on the golf ball core;

FIG. 16 shows a schematic, cross-sectional view of a second mold having mold surfaces to impart a second texture to a second layer of a golf ball with interlocking layers, with the mold in an open and empty configuration;

FIG. 17 shows the mold of FIG. 16 in a closed configuration with the molded product shown in FIG. 15 positioned within the mold cavity; and

FIG. 18 is an enlarged view of a portion of the mold of FIGS. 16 and 17, showing an embodiment of how the interlocking interface of the layers is formed.

### DETAILED DESCRIPTION

Generally, the present disclosure relates to a golf ball with interlocking layers. The interlocking layers are generally provided to improve durability, such as by inhibiting slippage of the adjacent layers, particularly due to shear forces and particularly between incompatible materials that are difficult to adhere together. Thus, the interlocking layers inhibit the development of dead spots within the ball, which occurs when the layers delaminate. The inventor posits that the interlocking construction of the layers improves durability due to the increased surface area of the interlocked layers. Thus, because the contact between the layers is increased, the shear forces between the layers are more dispersed and less likely to reach a critical point of causing separation or damage to the layers.

The layers may be any two layers of a solid golf ball or a golf ball with solid layers. However, this technology may be particularly appropriate for the cover layer and whichever layer is adjacent to the cover layer, since the cover layer is often made of a material that is somewhat incompatible with the other layers of a golf ball. For example, the cover layer may be made from an ionomer while the adjacent layer may be made from rubber. Often, an adhesive may be provided to secure adjacent layers made of incompatible materials. Other pairs of materials which may be particularly well-suited to use of this technology include but are not limited to ionomers and thermoplastic polyurethanes (TPU); ionomers and polyolefins; ionomers and polyurea; highly neutralized polymers and other ionomers; highly neutralized polymers and rubber; highly neutralized polymers and polyolefins; highly neutralized polymers and polyureas; and other materials know to or apparent to those of ordinary skill in the art. With interlocking layers, the use of adhesives may be reduced or eliminated.

At the interlocking interface of the two layers, surface texture of a first layer engages with and interlocks with surface texture of the facing surface of the second layer. In some embodiments, the surface texture on the first layer and the surface texture of the second layer are the same shape to facilitate the engagement of the surface texture.

The golf ball may be made by any suitable process. However, in some embodiments, the interlocking layers may be made using an injection molding process to facilitate the engagement of the layers. Exemplary processes are discussed below with respect to the individual layers of the exemplary embodiment.

As used herein, the terms “about” or “substantially” are intended to allow for engineering and manufacturing tolerances, which may vary depending upon the type of material and manufacturing process, but which are generally understood by those in the art. Also, as used herein, unless otherwise stated, compression, hardness, COR, and flexural modulus are measured as follows:

Compression deformation: The compression deformation herein indicates the deformation amount of the ball under a force; specifically, when the force is increased to become 130 kg from 10 kg, the deformation amount of the ball under the force of 130 kg subtracts the deformation amount of the ball under the force of 10 kg to become the compression deformation value of the ball. All of the tests herein are performed using a compression testing machine available from Automated Design Corp. in Illinois, USA. The ADC compression tester can be set to apply a first load and obtain a first deformation amount, and then, after a selected period, apply a second, typically higher load and determine a second deformation amount. Thus, the first load herein is 10 kg, the second load herein is 130 kg, and the compression deformation is the difference between the second deformation and the first deformation. Herein, this distance is reported in millimeters. The compression can be reported as a distance, or as an equivalent to other deformation measurement techniques, such as Atti compression.

Hardness: Hardness of golf ball layer is measured generally in accordance with ASTM D-2240, but measured on the land area of a curved surface of a molded ball. Other types of hardness, such as Shore C or JIS-C hardnesses may be provided as specified herein. For material hardness, it is measured in accordance with ASTM D-2240 (on a plaque).

Method of measuring COR: A golf ball for test is fired by an air cannon at an initial velocity of 131 ft/s, and a speed monitoring device is located over a distance of 0.6 to 0.9 meters from the cannon. When striking a steel plate positioned about 1.2 meters away from the air cannon, the golf ball rebounds through the speed-monitoring device. The return velocity divided by the initial velocity is the COR. A COR measuring system is available from ADC.

Durability: The durability is generally tested by repeatedly performing a COR test with the same ball for as many shots as possible until the ball fails or reaches 150 shots. If a material layer fails in any way, such as delamination with adjacent layers, buckling of the material, fracturing or cracking of the material, or otherwise, the ball will “deaden”. This deadening of the ball is determined by monitoring the COR. If the ball deadens, the COR will noticeably and suddenly reduce. In some instances, to specifically test for imparted shear forces, the steel plate in the COR test may be angled and, optionally, provided with ridges or other surface texture to increase the internal shear forces within the golf ball. The steel plate may be angled at any angle other than 90 degrees to the trajectory of the golf ball, such as 15 degrees, 30 degrees or 45 degrees to the trajectory of the ball.

Flexural Modulus: The material is measured generally in accordance with ASTM D790, which measures the deflection in a beam of the material in a three point bending system.

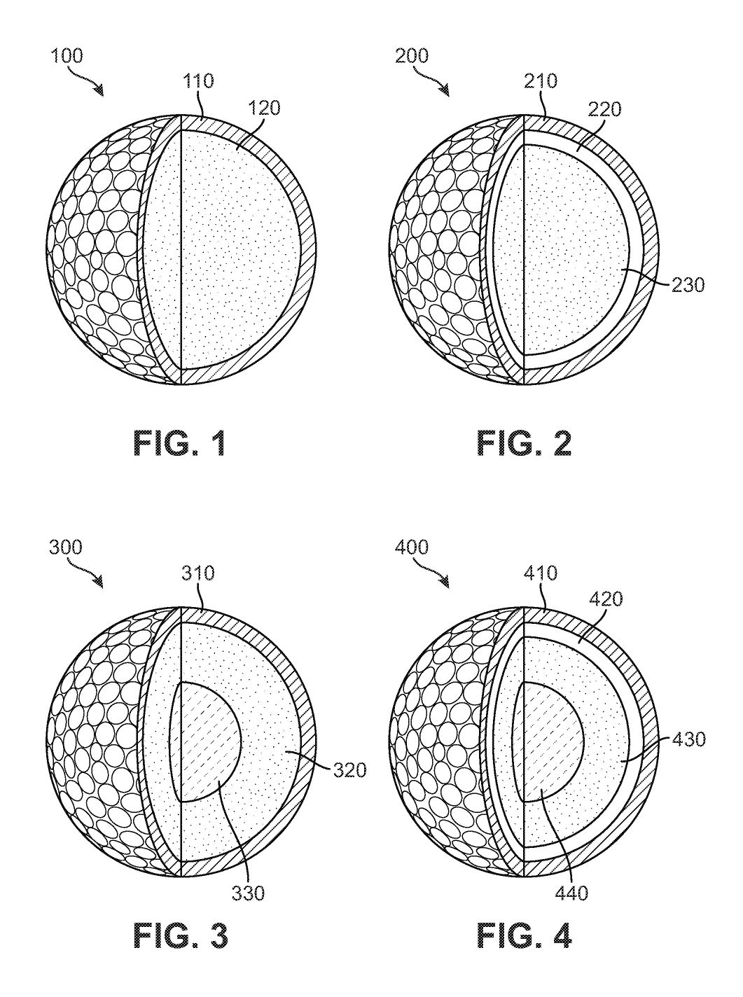

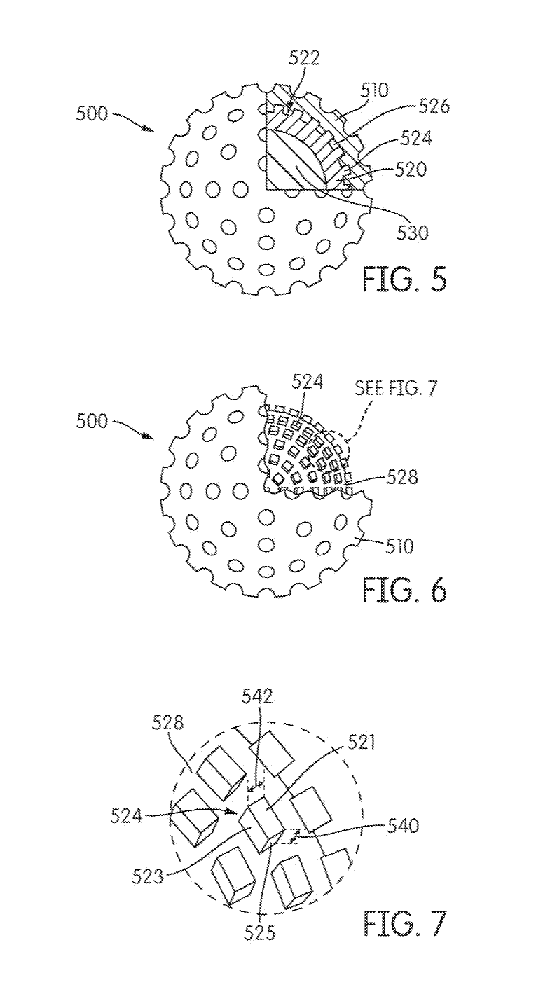

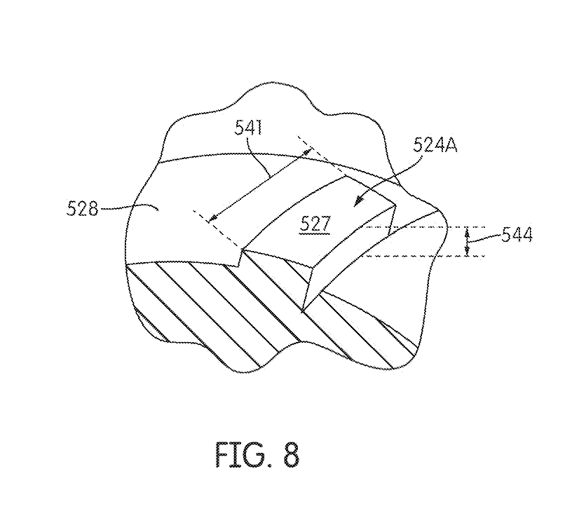

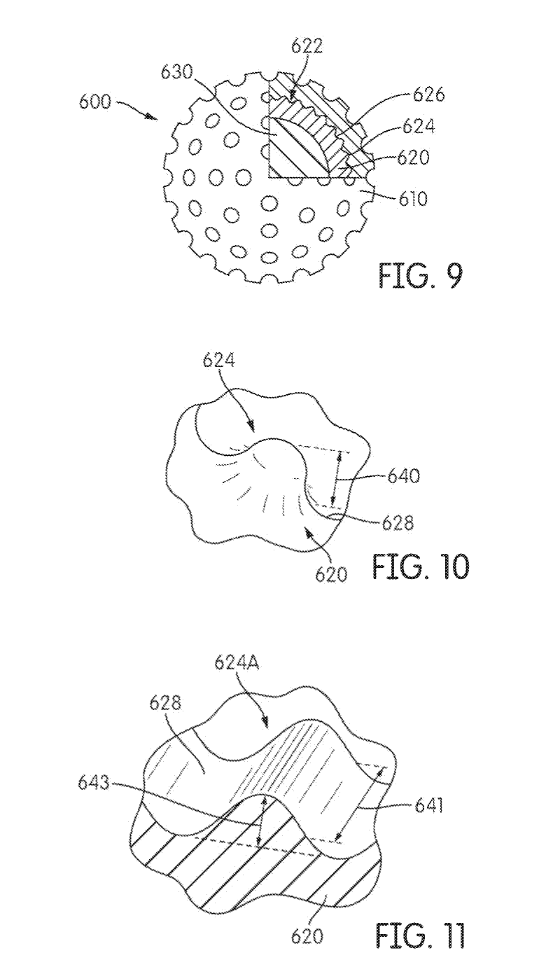

FIGS. 1-4 show various golf ball configurations with various combinations of the following layers: core, inner core, outer core, mantle, and cover. As shown in FIG. 1, golf ball configuration 100 is a two-piece golf ball with a core 120 and a cover 110. As shown in FIG. 2, golf ball configuration 200 is a three-piece golf ball with a core 230, a mantle 220, and a cover 210. As shown in FIG. 3, golf ball configuration 300 is a three-piece golf ball with an inner core 330, an outer core 320, and a cover 310. As shown in FIG. 4, golf ball configuration 400 is a four-piece golf ball with an inner core 440, an outer core 430, a mantle 420, and a cover 410. Each of these layers may have other names, as the industry does not have a standard naming convention for the layers of a solid golf ball. For example, an inner core may be called a center core if the inner core encompasses the center of a golf ball. Also, for example, a mantle layer may also be called an inner cover layer or an outer core layer and any layer between an inner core and an outer cover layer may be called an intermediate layer. In most embodiments, the cover layers include dimples and at least one coating layer, such as primer, paint, and clear coat layers.

Any of the layers noted above may be made from any known golf ball material, such as various well-known thermoset and thermoplastic materials. Suitable materials include rubber, either synthetic or natural, in particular polybutadiene rubber, resins, such as an ionomer resin, a highly neutralized polymer composition, a polyamide resin, a polyester resin, and a polyurethane resin, and mixtures or alloys of these materials. In some embodiments, the materials are foamed or are cellular in structure. Mixtures and alloys of these materials are also suitable, with additives and fillers included in the recipe to manipulate the properties of the materials, from hardness and specific gravity to melt flow.

Suitable additives and fillers may include, for example, blowing and foaming agents, optical brighteners, coloring agents, fluorescent agents, whitening agents, UV absorbers, light stabilizers, defoaming agents, processing aids, mica, talc, nanofillers, antioxidants, stabilizers, softening agents, fragrance components, plasticizers, impact modifiers, acid copolymer wax, surfactants. Suitable fillers may also include inorganic fillers, such as zinc oxide, titanium dioxide, tin oxide, calcium oxide, magnesium oxide, barium sulfate, zinc sulfate, calcium carbonate, zinc carbonate, barium carbonate, mica, talc, clay, silica, lead silicate. Suitable fillers may also include high specific gravity metal powder fillers, such as tungsten powder and molybdenum powder. Suitable melt flow modifiers may include, for example, fatty acids and salts thereof, polyamides, polyesters, polyacrylates, polyurethanes, polyethers, polyureas, polyhydric alcohols, and combinations thereof.

Interlocking layers may be provided in any of the exemplary golf ball configurations shown in FIGS. 1-4 or any other variation of known golf ball configurations, and the interlocking interfaces may be between any two adjacent layers in any of those golf ball configurations. However, as discussed above, this technology may be particularly advantageous for the cover layer and the layer directly adjacent to the cover layer. Therefore, for the sake of clarity and simplicity, the embodiments disclosed herein are discussed with respect to the cover layer and an adjacent intermediate layer. However, the invention should not be considered to be so limited.

FIG. 5 shows a first golf ball 500 having interlocking layers. First golf ball 500 includes a first cover 510, a first intermediate layer 520, and a first core 530. Between first cover 510 and first intermediate layer 520 is a first interlocking interface 522. As can be seen in FIG. 5, first intermediate layer 520 includes first texture 524 and first cover 510 includes second layer first texture 526. First texture 524 is configured to engage with or interlock with second layer first texture 526. Both first texture 524 and second layer first texture 526 may have any configuration capable of engaging with each other. In this embodiment, for example, as shown best in FIG. 6, first texture 524 includes a plurality of cubical protrusions that extend away from first intermediate layer surface 528.

As shown in FIG. 7, first texture 524 includes a number of faces, such as first texture first side 523 and first texture second side 525, which rise a first texture height 540 above first intermediate layer surface 528 to first texture upper surface 521. Each of first texture first side 523 and first texture second side 525 have a first texture width 542. In this embodiment, since first texture 524 is generally cubical, first texture height 540 and first texture width 542 are about the same. First texture height 540 and first texture width 542 may be any desirable height or width compatible with being provided on the surface of a golf ball. In some embodiments, first texture height 540 may be on the same scale as typical dimple textures, which range from about 0.1 mm to about 0.25 mm in scale. In other embodiments, first texture height 540 may be less than the dimple depth, such as a quarter or half of the dimple depth, while in yet other embodiments, first texture height 540 may be greater than the dimple depth, such as twice or triple the dimple depth. First texture height 540 may range from about 0.05 mm to about 1 mm, and is only limited by manufacturing capabilities and the thickness of the layers. In many embodiments, it may be preferably for first texture height 540 to be only large enough to permit engagement to inhibit slippage while not being so large as to affect golf ball performance parameters such as compression or COR.

Though not shown with specificity in the figures, second layer first texture 526 is also a plurality of cubical protrusions that extend away from the cover layer surface. Having the same general shape, first texture 524 and second layer first texture 526 can more easily engage with each other. However, in other embodiments, first texture 524 and second layer first texture 526 may have different configurations or the same shape but in different sizes, as long as some portion of first texture 524 can engage with some portion of second layer first texture 526.

First interlocking interface 522 shown in FIG. 5 is shown as having a generally square cross-sectional shape for first texture 524. In the embodiment shown in FIGS. 6 and 7, first texture 524 is generally cubical. However, the cross-sectional shape may also correspond to an elongated rib, such as second texture 524A shown in FIG. 8. Similar to first texture 524, second texture 524A rises a second texture height 544 above first layer surface 528. Unlike first texture 524, second texture 524A has a second texture length 541 that is longer than second texture height 544. Second texture length 541 may be any length that gives second texture 524A an elongated configuration. In some embodiments, second texture length 541 may be sufficient to encircle the entirety of the layer. In other embodiments, second texture length 541 may be less than the circumference of first intermediate layer 520 (shown in FIG. 5).

In other embodiments, the surface texture of the interlocking layers may have other configurations. FIGS. 9-11 show some alternate configurations of surface texture capable of interlocking to inhibit slippage between layers of a golf ball. As shown in FIG. 9, a second golf ball 600 is shown that includes a second cover 610, a second intermediate layer 620, and a second core 630. Second golf ball 600 also includes a second interlocking interface 622 between second intermediate layer 620 and second cover 610. Third texture 624 is provided on second intermediate layer 620 to engage with fourth texture 626, which is provided on second cover 610. As shown in FIG. 9, the interlocking configuration is similar to sinusoidal waves.

FIG. 10 shows a first embodiment of a type of texture that can yield the interlocking configuration shown in FIG. 9. Third texture 624 is a rounded protrusion, such as a bump or a hill-shapes protrusion having a substantially conical shape proximate second intermediate layer surface 628 and a rounded top. In those embodiments where the corresponding texture on second cover 610 (shown in FIG. 9) is the same rounded shape, then second intermediate layer 628 may also be rounded to accommodate the texture. In other words, as shown in FIG. 9, second intermediate layer 620 has a wave-like shape at second interlocking interface 622 with peaks at the tops of third texture 624 and valleys between adjacent texture elements.

Third texture 624 rises a third texture height 640 away from second intermediate layer surface 628. As discussed above with respect to first texture height 540, third texture height 640 may be any height that second intermediate layer 620 can accommodate. However, it may be desirable to make third texture height 640 only large enough to effectively engage with the corresponding texture on second cover 610 while being small enough not to interfere with the flexural and compression properties of second intermediate layer 620. In some embodiments, third texture height 640 may be about a quarter of the dimple depth on second cover 610. In other embodiments, third texture height 640 may be about a half of the dimple depth on second cover 610. In other embodiments, third texture height 640 may be about the same as the dimple depth on second cover 610. In some embodiments, these relationships to the dimple depth may range from about 0.05 mm to about 1 mm or even greater.

FIG. 11 shows a second embodiment of a type of texture that can yield the interlocking configuration shown in FIG. 9. Similar to third texture 624, fourth texture 624A is a rounded protrusion that rises a fourth texture height 643 above second intermediate layer surface 628, where fourth texture height 643 is similar to third texture height 641 described above. However, similar to second texture 524A shown in FIG. 8 and discussed above, fourth texture 624A is an elongated member having a fourth texture length 641. Fourth texture length 641 is similar to second texture length 541, described above.

The surface textures described above are representative only, and are not intended to limit the interpretation of the claims unless specified within the claims. Other types of texture in terms of shape, contour, height, and material properties will be readily apparent to those in the art.

Further, the embodiments discussed above generally consider that the surface texture is formed of the same material as that of the layer. For example, first texture 524 is an extension of, contiguous with, and made of the same material as first intermediate layer 522. In some embodiments, any of the textures may be applied to any of the layers. However, for ease of manufacturing, co-forming the texture with the layer from which the texture extends.

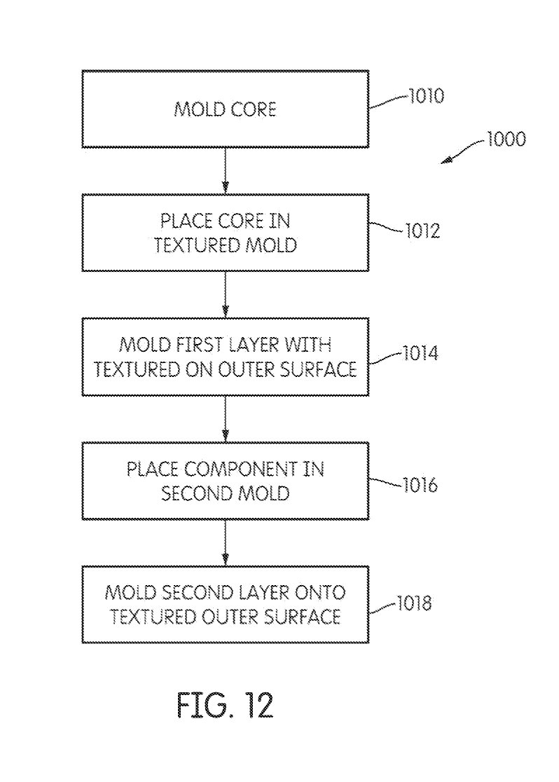

A golf ball with textured layers may be made using any manufacturing technique. However, FIGS. 12-18 show an embodiment of a manufacturing method that may be particularly well suited for manufacturing a golf ball with textured layers.

FIG. 12 is a flowchart showing the basic steps of a method 1000 of making a golf ball with interlocking layers. Method 1000 assumes that the interlocking layers are outer layers of a golf ball, such as a mantle layer and a cover layer. Therefore, in an initial step, step 1010, a core is molded. This step may be optional where the core is one of the interlocking layers. In step 1010, the core may be molded using any technique known in the art, such as compression molding, injection molding, or combinations of these techniques.

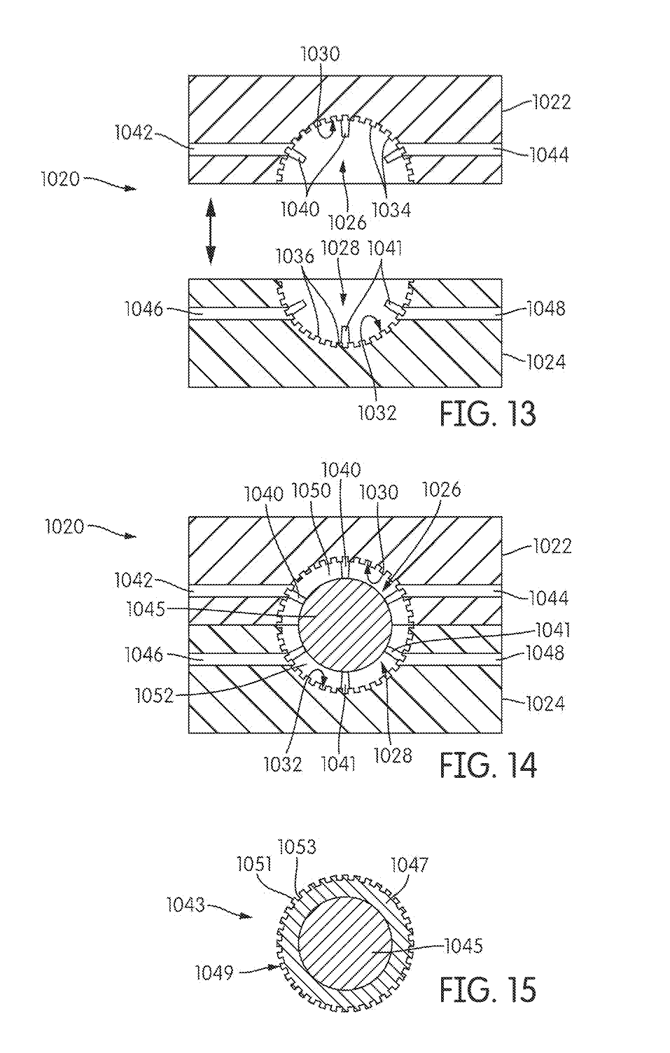

In a second step, step 1012, the core is placed in a textured mold. Again, this may be an optional step if the core is one of the interlocking layers. An embodiment of step 1012 is illustrated in FIGS. 13 and 14, where a first mold 1020 is provided. First mold 1020 is configured to impart the interlocking surface texture to an outer surface of the layer being molded. First mold 1020 is shown as mold configured for injection molding, though in other embodiments, first mold 1020 may be a mold configured for compression molding.

First mold 1020 includes a first upper mold half 1022 and a first lower mold half 1024. First upper mold half 1022 defines a first mold cavity 1026 and first lower mold half 1024 defines a second mold cavity 1028. First mold cavity 1026 has a first mold surface 1030 and second mold cavity 1028 has a second mold surface 1032. First mold 1020 is configured to open and close by articulating first upper mold half 1022 and first lower mold half 1024 towards and away from each other. When mold 1020 is closed, first mold cavity 1026 and second mold cavity 1028 align, first mold surface 1030 and second mold surface 1032 mate to form a complete mold surface that defines the shape of the desired golf ball layer, in this case, a mantle layer.

First mold surface 1030 includes first mold surface texture 1034 and second mold surface 1032 includes second mold surface texture 1036. First mold surface texture 1034 and second mold surface texture 1036 are in most embodiments the same texture, though it is possible that in some embodiments these surface textures are different. First mold surface texture 1034 and second mold surface texture 1036 are negative images of the interlocking texture of the layers so that the material in the mold will take on the desired interlocking texture; such molding techniques are well known in the art.

First mold 1020 is configured as a mold for injection molding, so several injection mold gates are provided for the introduction of melt into first mold cavity 1026 and second mold cavity 1028. Only four gates are shown—first gate 1042 and second gate 1044 in first upper mold half 1022 and third gate 1046 and fourth gate 1048 in lower upper mold half 1024—but any number of gates can be provided. In typical golf ball molding operations, between six (6) and twelve (12) gates are usually provided for an even introduction of melt into the system.

First mold 1020 is also provided with optional pins for holding a part in position within first mold cavity 1026 and second mold cavity 1028 so that the melt introduced into first mold 1020 can overmold the part. First upper mold half 1022 includes three (3) first pins 1040 and first lower mold half 1024 includes three (3) second pins 1042. While three pins are shown, any number of pins, from one (1) to six (6) or even more, may be provided to provide a desired level of positioning and stability. In some embodiments, the pins may be retractable. The structure of retractable pins and timing and control of the retraction during the melt injection are well known in the art.

FIG. 14 shows first mold 1020 in a closed position, with a core 1045 positioned within first mold cavity 1026 and second mold cavity 1028 on first pins 1040 and second pins 1042. When first mold 1020 is closed and core 1045 is positioned within first mold cavity 1026 and second mold cavity 1028, a first gap 1050 is defined between first mold surface 1030 and core 1045 and a second gap 1052 is defined between second mold surface 1032 and core 1045. First gap 1050 and second gap 1052 will be filled with melt to mold the first of the interlocking layers, in this embodiment a mantle layer, per step 1014 of the method shown in FIG. 12.

This molding step forms a component 1043, shown in FIG. 15. Component 1043 includes core 1045 and intermediate layer 1047. Intermediate layer 1047 includes surface texture 1049, which is comprised of a plurality of texture elements 1051. In between adjacent texture elements 1051 are interstitial spaces 1053. The surface texture on the adjacent layer, which is, in this embodiment, a cover layer, is formed by introducing melt to fill interstitial spaces 1053. This occurs in placing step 1016 and second layer molding step 1018 of the method in FIG. 12.

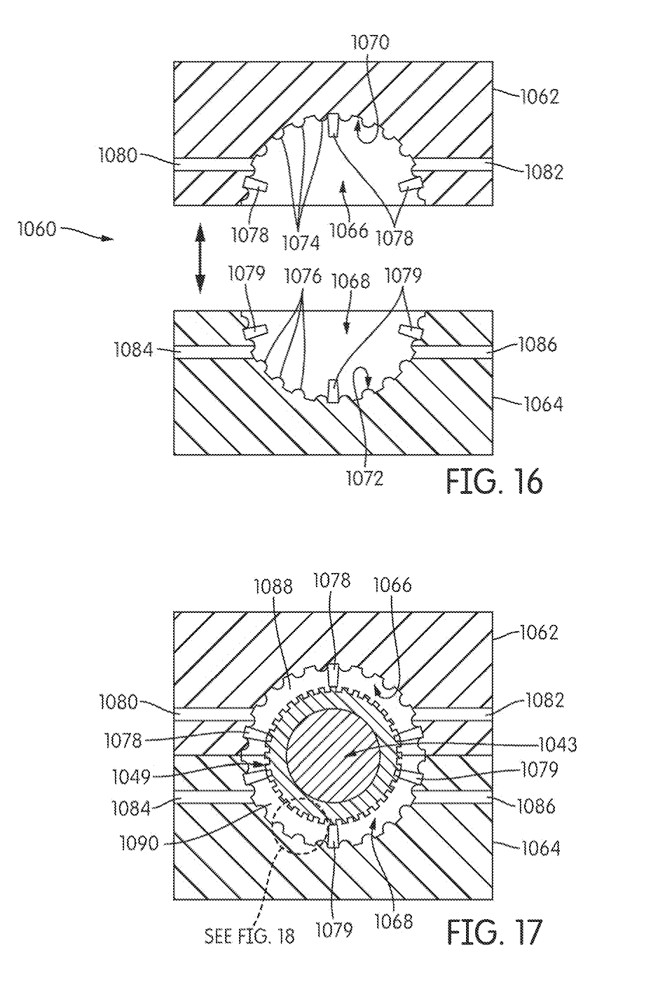

As shown in FIG. 16, a second mold 1060 is provided for placing step 1016 and second layer molding step 1018. Second mold 1060 is similar to first mold 1020. Second mold 1060 includes a second upper mold half 1062 and a second lower mold half 1064. Second upper mold half 1062 defines a third mold cavity 1066. Third mold cavity 1066 includes a third mold surface 1070 with optional third surface texture 1074. Because the layer to be molded in this step in this embodiment is a cover layer, third surface texture 1074 are negative images of the dimples on the outer surface of the cover. Similarly, second lower mold half 1064 defines a fourth mold cavity 1068. Fourth mold cavity 1068 includes a fourth mold surface 1072 with optional fourth surface texture 1076. Fourth surface texture 1076 is also configured to impart dimples on the outer surface of the cover layer.

Second mold 1060 is configured to mold using injection molding techniques. As such, various gates are provided. Second upper mold half 1062 includes fifth gate 1080 and sixth gate 1082. Second lower mold half 1064 includes seventh gate 1084 and eighth gate 1086. As discussed above, any number of gates may be provided.

As shown in FIG. 16, second mold 1060 is also provided with pins for holding component 1043 in position within third mold cavity 1066 and fourth mold cavity 1068 so that the melt introduced into second mold 1060 can overmold component 1043. Second upper mold half 1062 includes three (3) third pins 1078 and second lower mold half 1064 includes three (3) fourth pins 1079.

While three pins are shown, any number of pins, from one (1) to six (6) or even more may be provided to provide a desired level of positioning and stability. In some embodiments, the pins may be retractable. The structure of retractable pins and timing of the retraction during the melt injection are well known in the art.

FIG. 17 shows second mold 1060 in a closed position, with component 1043 positioned within third mold cavity 1066 and fourth mold cavity 1068, and lifted away from third mold surface 1070 by third pins 1078 and fourth pins 1079. When second mold 1060 is closed and component 1043 is positioned within third mold cavity 1066 and fourth mold cavity 1068, a third gap 1088 is defined between third mold surface 1070 and component 1043 and a fourth gap 1090 is defined between fourth mold surface 1072 and component 1043. Third gap 1088 and fourth gap 1090 will be filled with melt to mold the first of the interlocking layers, in this embodiment a mantle layer, per step 1018 of the method shown in FIG. 12.

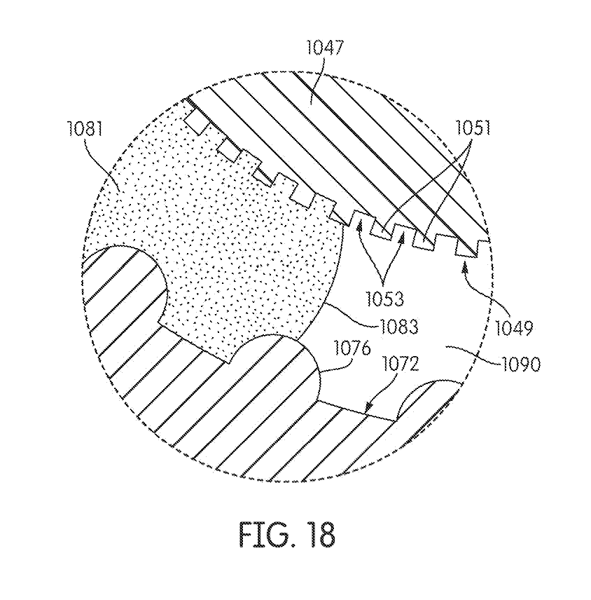

FIG. 18 is an enlarged view of a portion of second mold 1060 to show how the surface texture on the inner surface of the cover layer as melt is introduced into fourth gap 1090. FIG. 18 shows fourth mold surface 1072 with fourth surface texture 1076 and intermediate layer 1047 with surface texture 1049 forming another mold surface in this overmolding step. As can be clearly seen, texture elements 1051 and interstitial spaces 1053 are also part of the mold surface presented by intermediate layer 1047.

As melt 1081 is introduced into fourth gap 1090, the melt front 1083 flows into interstitial spaces 1053, thereby filling interstitial spaces 1053. Thus, the layer being molded takes on the shape of interstitial spaces 1053 at the interlocking interface. This overmolding step allows the surface texture of the cover layer to conform closely to the shape of interstitial spaces 1053 and to be readily fitted within interstitial spaces 1053. This methodology allows for the interlocking layers to be formed without taking expensive, difficult, and or labor-intensive steps such as precision molding, alignment, and attachment steps.

Because texture elements 1051 and interstitial spaces 1053 may be small and somewhat delicate, it may be desirable that the material used in the second molding step have a lower melt and/or glass transition temperature than the material used in the first molding step so that texture elements 1051 are not damaged, deformed, or destroyed during the second molding step. In other embodiments, such deformation may be insignificant or tolerable.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A solid golf ball comprising:
a first layer having a first surface texture on a first surface; and
a second layer having a second surface texture on a second surface, wherein the second surface is adjacent to and touches the first surface, and
wherein the first surface texture is configured to interlock with the second surface texture.

2. The solid golf ball of claim 1, wherein the first layer is a core and the second layer is a cover.

3. The solid golf ball of claim 1, wherein the first layer is an intermediate layer, and the second layer is a cover.

4. The solid golf ball of claim 1, wherein the first layer is a first intermediate layer, and the second layer is a second intermediate layer.

5. The solid golf ball of claim 1, wherein the first layer is a core and the second layer is an intermediate layer.

6. The solid golf ball of claim 1, wherein the first layer is made of a first material and the second layer is made of a second material, and wherein the first material is incompatible with the second layer.

7. The solid golf ball of claim 1, wherein the first surface texture extends a first height above a first layer surface.

8. The solid golf ball of claim 7, wherein a cover layer of the golf ball includes at least one dimple having a dimple depth, and wherein the first height is less than the dimple depth.

9. The solid golf ball of claim 8, wherein the first height is less than half the dimple depth.

10. The solid golf ball of claim 1, wherein the first surface texture is a first geometric solid and the second surface texture is a second geometric solid, wherein the first geometric solid is the same as the second geometric solid.

11. The solid golf ball of claim 10, wherein the first surface texture is a rib.

12. A method of making a golf ball comprising:
forming a first layer in a first mold, wherein the first mold has a mold surface with a first surface texture so that a first surface of the first layer is textured during the molding process with a second surface texture;
positioning the first layer in a mold cavity of a second mold so that a gap is provided between the first layer and a second mold surface; and
introducing material into the gap so that the material conforms to the second surface texture of the first surface of the first layer.

13. The method of claim 12, wherein the step of introducing material into the gap is performed using an injection molding technique.

14. The method of claim 12, wherein the gap is formed by suspending the first layer in the mold cavity with pins.

15. The method of claim 14, further comprising the step of retracting the pins during the step of introducing material into the gap.

16. The method of claim 12, wherein the first layer is an intermediate layer and further comprising the steps of:
molding a core; and
positioning the core within a first mold cavity of the first mold so that a first gap is formed between an outer surface of the core and the mold surface,
wherein the step of forming the first layer is accomplished by introducing a first material into the first gap.

17. The method of claim 16, wherein the step of forming the first layer is accomplished using an injection molding technique.

18. The method of claim 16, wherein the second mold surface includes a third texture.

19. The method of claim 16, wherein the gap is formed by using pins to hold the core away from the mold surface.

20. The method of claim 19 further comprising the step of retracting the pins during the step of introducing material into the gap.
